(19) United States
(12) Patent Application Publication
(10) Pub. No.: US 2009/0222686 A1
(43) Pub. Date: Sep. 3, 2009

(54) SELF MAINTAINED COMPUTER SYSTEM UTILIZING ROBOTICS

(75) Inventors: John P. Nibarger, Superior, CO (US); Kevin D. McKinstry, Denver, CO (US)

Correspondence Address: BROOKS KUSHMAN P.C. / SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 12/041,305

(22) Filed: Mar. 3, 2008

(51) Int. Cl. G06F 11/20

(52) U.S. Cl. 714/3; 714/E11.071; 901/1

(57) ABSTRACT

A self-maintained computer system includes a computer system having a plurality of interconnected computer components and a robot associated with the computer system that is configured to carry a spare computer component and further configured to replace a computer component of the computer system with the spare computer component. The robot automatically replaces an individual computer component when a failure of the individual computer component is detected.

### BACKGROUND OF THE INVENTION

1. Field of the Invention

The invention disclosed herein relates to a self maintained computer system having interconnected computer components and a robot for automatically replacing computer components that fail. The field of the invention also includes a method for implementing such a computer system.

2. Background Art

Massive computer systems having tens of thousands or hundreds of thousands of processors, tens or hundreds of terabytes of memory, and tens of petabytes of storage capacity face a unique challenge with regards to keeping the system running. Each computer component has a predictable life span resulting in a predictable mean time to failure. For example, with a mean time to failure of 400,000 hours for 10,000 disks over a three month period, the number of failures a system would experience would be 54 drives.

Such massive computer systems are typically maintained using a preventative maintenance regime wherein components that have failed are allowed to remain in the system for a period of time until preventative maintenance can be performed by a human caretaker.

System planners aware of component failure rates have developed robust computer systems. For example, some computer systems use redundancy as a means of dealing with the problem of component failure. Such systems rely on redundancy of components to continue functioning until the failed component can be replaced. For example, in a storage system utilizing hard disk drives, one strategy is a RAID system (Redundant Array of Independent Drives). By storing data on more than one disk, a computer system employing a RAID protocol can tolerate the loss of one or more components. For instance, a RAID 5 system employing five disk drives can tolerate the loss of one disk drive and still function without any data loss. The system continues to operate without the failed component until the failed component is replaced during the performance of the preventative maintenance.

More robust RAID protocols which can tolerate higher numbers of component failures can be employed, but they require correspondingly more hardware. Such systems are very expensive, both in terms of equipment and overhead. In some computer systems, the inability to tolerate the loss of data may justify the use of such an expensive redundancy protocol, but a less costly solution is needed.

Rather than increasing the redundancy of a computer system to enhance its ability to withstand multiple component failures during periods in-between regularly scheduled preventative maintenance, it would be advantageous to replace failed components as soon as their failure is detected. The invention described herein addresses this and other problems.

### SUMMARY OF THE INVENTION

In a first aspect of the invention, a self maintained computer system is disclosed herein. In a first embodiment, the self maintained computer system includes a computer system having a plurality of interconnected computer components and a robot associated with the computer system that is configured to carry a spare computer component and further configured to replace a computer component of the computer system with the spare computer component. The robot automatically replaces an individual computer component when a failure of the individual computer component is detected.

In one implementation of the first embodiment, the robot may be configured to carry a plurality of the spare computer components.

In another implementation of the first embodiment, the plurality of interconnected computer components includes a plurality of different types of computer components. The robot may be configured to carry each different type of computer component utilized by the computer system. In some variations of this implementation, the plurality of different types of computer components may include a server. In other variations, the plurality of different types of computer components may include a component selected from a group consisting of a power supply, a battery, and a cooling device. In still other variations, the plurality of different types of computer components may include a storage device.

In another implementation of the first embodiment, the plurality of interconnected computer components may be positioned in a generally rectangular arrangement. In one variation of this implementation, the generally rectangular arrangement of computer components forms a wall wherein individual components of the computer system are accessible from both a front portion of the wall and from a rear portion of the wall.

In another implementation of the first embodiment, the computer system may further include a plurality of spare computer components detachably connected to the robot.

In still another implementation of the first embodiment, the computer system may have a RAID protocol.

In a second embodiment, a self maintained computer system includes a computer system having a plurality of interconnected computer components, a repository associated with the computer system having a spare computer component in good working order a robot associated with the computer system that is configured to carry the spare computer component from the repository to the computer system. The robot is further configured to replace an individual component of the computer system with the spare computer component. In this second embodiment, one of the computer system and the robot is capable of detecting a failure of any individual computer component of the computer system. The robot automatically replaces a failed computer component with the spare computer component upon the detection of a failure of an individual computer component of the computer system.

In one implementation of the second embodiment, the repository is disposed proximate the computer system.

In another implementation of the second embodiment, the repository is a first repository and the self maintained computer system further includes a second repository. The robot is configured to deliver failed computer components from the computer system to the second repository. In one variation of this implementation, the second repository is disposed in close proximity to the first repository.

In another implementation of the second embodiment, the plurality of interconnected computer components are positioned in a generally rectangular arrangement. In a variation of this implementation, the generally rectangular arrangement of computer components forms a wall wherein individual components of the computer system are accessible from both a front portion of the wall and from a rear portion of the wall.

In a second aspect of the invention, a method of maintaining a computer system is disclosed. In a first embodiment of the method, the method includes providing a computer system having a plurality of interconnected computer components, providing a repository having a spare computer component in good working order, and providing a robot that is configured to carry the spare computer component and further configured to replace an individual computer component of the computer system with the spare computer component. The method further includes the step of detecting a failure of one of the computer components of the computer system, retrieving the spare computer component from the repository using the robot, transporting the spare component to a location within the computer system where the failed computer component is located using the robot, and replacing the failed computer component of the computer system with the spare computer component using the robot.

In one implementation of this method, the repository is a first repository and the method further includes the steps of providing a second repository and delivering the failed computer component to the second repository using the robot.

In another implementation, the repository may have a plurality of the spare computer components. The method further includes the step of recording which spare components have been retrieved from the repository. In one variation, the method may further include the step of communicating a message to a remote location identifying which spare components have been retrieved from the repository.

### BRIEF DESCRIPTION OF TEE DRAWINGS

The description herein makes reference to the accompanying drawing wherein like reference numerals refer to like parts through the several views, and in which:

FIG. 1 is a fragmentary perspective view of an embodiment of a self maintained computer system made in accordance with the teachings of the present invention;

FIG. 2 is a fragmentary perspective view of an alternate embodiment of the self maintained computer system illustrated in FIG. 1;

FIG. 3A is a fragmentary perspective view illustrating a robot removing a failed computer component from the computer system of FIG. 1;

FIG. 3B is a fragmentary perspective view illustrating the robot of FIG. 3A replacing the failed computer component with a spare computer component;

FIG. 4 is a block diagram illustrating an embodiment of the method of the present invention;

FIG. 5 is a perspective view illustrating an alternate embodiment of a self-maintained computer system made in accordance with the teachings of the present invention;

FIG. 6 is a plan view illustrating an alternate embodiment of the self-maintained computer system of FIG. 5; and

FIG. 7 are side elevational views of embodiments of the self-maintained computer system of FIG. 6.

### DETAILED DESCRIPTION OF THE PREFERRED EMBODIMENT(S)

Detailed embodiments of the present invention are disclosed herein; however, it is to be understood that the disclosed embodiments are merely exemplary of the invention that may be embodied in various and alternative forms. The figures are not necessarily drawn to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

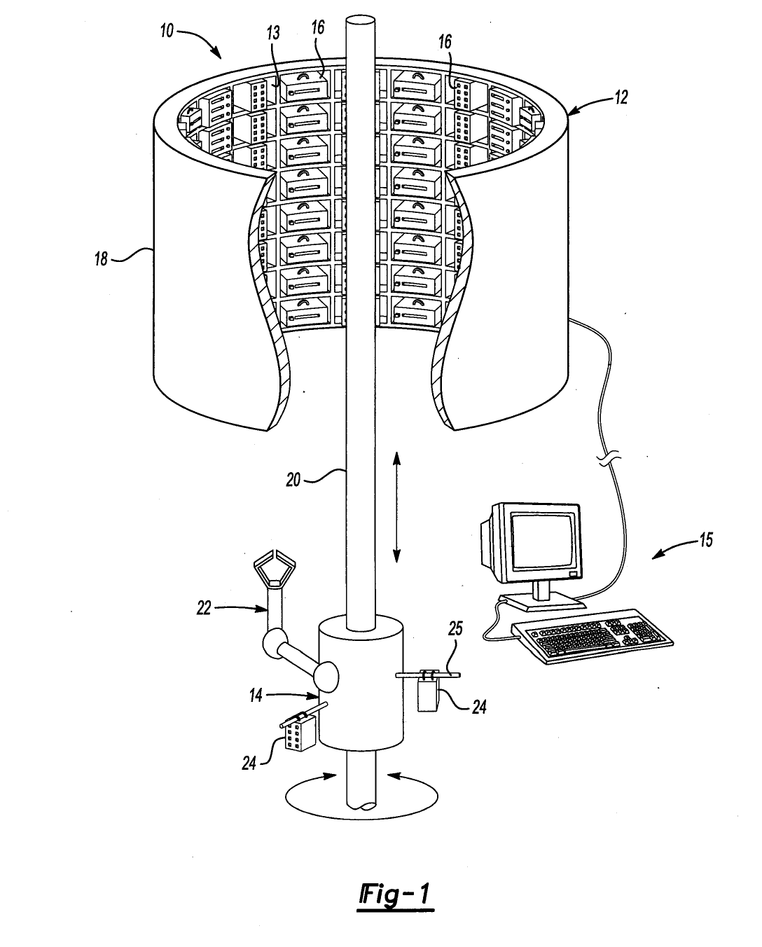

The invention disclosed herein relates to a self maintained computer system having a plurality of interconnected computer components and a robot associated with the computer system that removes computer components which have failed and that replaces those failed computer components with spare computer components in good working order. With reference to FIG. 1, an embodiment of a self maintained computer system 10 is illustrated. Self maintained computer system 10 includes a computer system 12 and a robot 14. In some embodiments, a computer terminal 15 may be included.

Computer system 12 includes a plurality of individual computer components 16 housed in a plurality of respective component receptacles 13 in a silo shaped cabinet. The plurality of computer components 16 are interconnected with one another such as through docking fixtures and hardwires, through infrared links, through optical fiber interconnects, or through the transmission of electromagnetic radiation such as is used in WIFR networks. Individual computer components 16 may be interconnected with one another through any combination of one or more of the above referenced methods or through one or more other methods conventionally used to link individual components of a computer system with one another. Computer system 12 may include different types of computer components. For instance, in one case, computer component 16 may be a server. As used herein, the term “server” refers to a computer in a network that is used to provide services, such as access to files or to shared peripherals, to other computers in the network. In another case, computer component 16 may be a power supply for other components in computer system 12 that need power. In another case, computer component 16 may be a disk drive. Or computer system 12 may include other components such as the central processing units, storage devices, processing units, random access memory (RAM), motherboards, routers, fiber channel switches, storage devices, disk drives, disk arrays, tape drives, batteries, and fans. Computer system 12 may include any combination of the above referenced components. In other embodiments, computer system 12 may include only one type of computer component. The principles of the present invention apply equally well regardless of whether computer system 12 includes only a single type of computer component or a variety of different computer components.

Robot 14 is mounted to rail 20 and may move in either an upward or downward direction along rail 20 which is mounted coaxially with a central axis of cabinet 18. Robot 14 is also capable of rotating about rail 20 in either a clockwise or a counterclockwise direction for up to, and in some applications, exceeding, 360°. In this manner, robot 14 has access to each individual computer component 16 of computer system 12. Robot 14 includes a robotic arm 22 which projects from the body of robot 14 in a generally outward direction. Robotic arm 22 may be dimensioned to reach from robot 14 to any individual computer component 16 within cabinet 18. To access an individual computer component 16, robot 14 need only slide upward or downward along rail 20 to a height comparable to the height of the computer component 16 that robot 14 has been tasked to access, rotate to an angular orientation that corresponds to that computer component 16 and extend robotic arm 22 towards that computer component to access it. Robot arm 22 may include appendages that are configured to dock with computer component 16 or which are otherwise configured to manipulate computer component 16.

Mounted on robot 14 are spare computer components 24. Robotic arm 22 is configured to not only access the individual computer components 16 mounted in cabinet 18, but is also configured to access spare computer components 24 attached to, mounted on, or housed within robot 14. In this manner, robot 14 is configured to carry spare computer components 24 throughout cabinet 18 and, through the use of robotic arm 22, may remove failed computer components 16 and replace them with spare computer components 24.

Those of ordinary skill in the art will appreciate that the invention of the present invention may be carried out in a wide variety of configurations. For instance, while cabinet 18 is depicted as a silo, it should be understood that other geometries may also be employed. For instance, cabinet 18 may have a horse shoe shaped cross section or may take the form of a cylinder with individual computer components 16 mounted honeycomb style along an outer wall of cabinet 18. In instances where cabinet 18 is configured to have a horse shoe cross section, robot 14 may run up and down along a centrally disposed rail similar to rail 20 in the same manner as indicated in FIG. 1. Varying distances between robot 14 and the inner walls of such a horse shoe shaped cabinet may be accounted for in the design of robotic arm 22. In instances where cabinet 18 has a cylindrical shape, a robot may be disposed outside of the cabinet and may be configured to revolve around the cabinet to access the individual computer components. Alternatively, the cylindrical cabinet itself may rotate to give an angularly stationary robot access to each component along the cabinet's perimeter, the robot needing only to move longitudinally with respect to the cylinder.

In still other embodiments, the computer system 12 may include a generally rectangular cabinet or a plurality of generally rectangular cabinets arranged linearly. Such cabinets may be equipped with a track or rail running along a length of the linearly arranged cabinets with a robot mounted thereto.

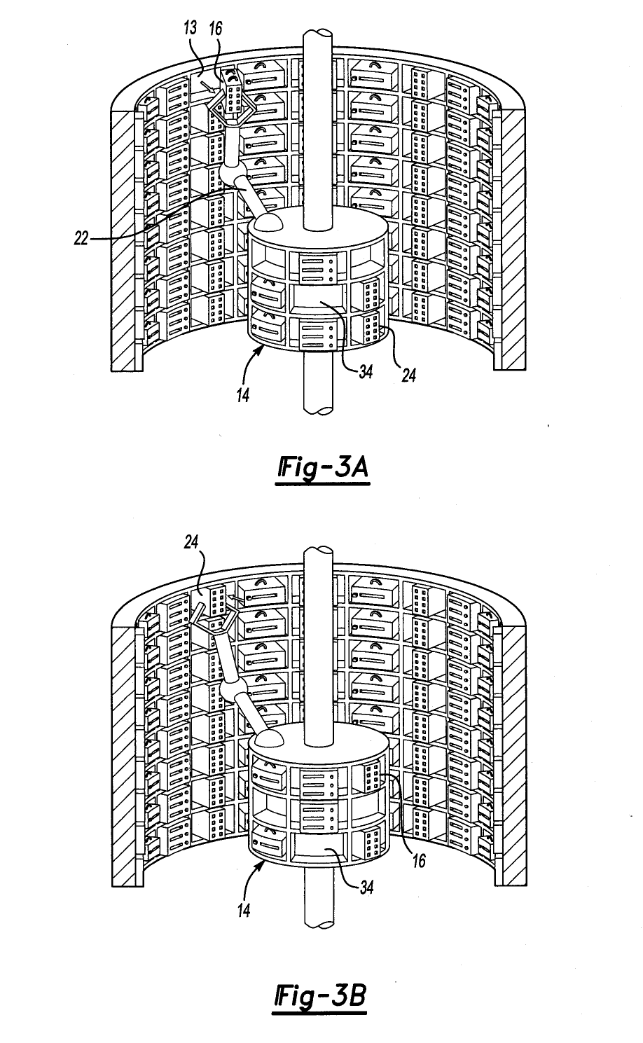

One of ordinary skill in the art should also appreciate that robot 14 has been depicted as a generally cylindrical body having a single robotic arm and that rides up and down and rotates about a pole-shaped rail 20, robot 14 may take other forms. For instance, rail 20 may take the form of a generally rectangular track along which robot 14 rides in a generally upward and downward direction. In such embodiments, robot 14 may be configured to allow portions of robot 14, including those portions to which robotic arm 22 is mounted, to spin with respect to a main body of robot 14. In other embodiments, robot 14 may include a plurality of robot arms 22 capable of reaching each computer component receptacle 13 from a single angular orientation thus negating the need for robot 14 to rotate. Robot 14 may include a plurality of mounting points 25 to allow spare components 24 and failed computer components 16 to be mounted to robot 14. In other embodiments, robot 14 may be cylindrical in shape and have a honeycomb array of compartments (see FIGS. 3A and 3B) for carrying spare computer components 24 and failed computer components 16. In other embodiments, a main body portion of robot 14 need not be configured to carry failed computer components 16 or spare computer components 24, such computer components being carried one at a time by robotic arm 22.

Although cabinet 18 is depicted with a central axis oriented in a generally vertical orientation, it should be understood that the teachings of the present invention are also compatible with other orientations such as a silo-shaped cabinet with a central axis oriented in a substantially horizontal orientation or any orientation between the vertical and the horizontal.

Computer system 12 may be configured to monitor the operational status of each individual computer component 16. In some embodiments, individual computer components 16 may monitor its own operational status and report that status to computer system 12. In other embodiments, robot 14 or other mechanisms external to computer system 12 may monitor the operational status of individual computer components 16. When the failure of an individual computer component 16 is detected, self-maintained computer system 10 will send instructions to robot 14 to replace the failed computer component.

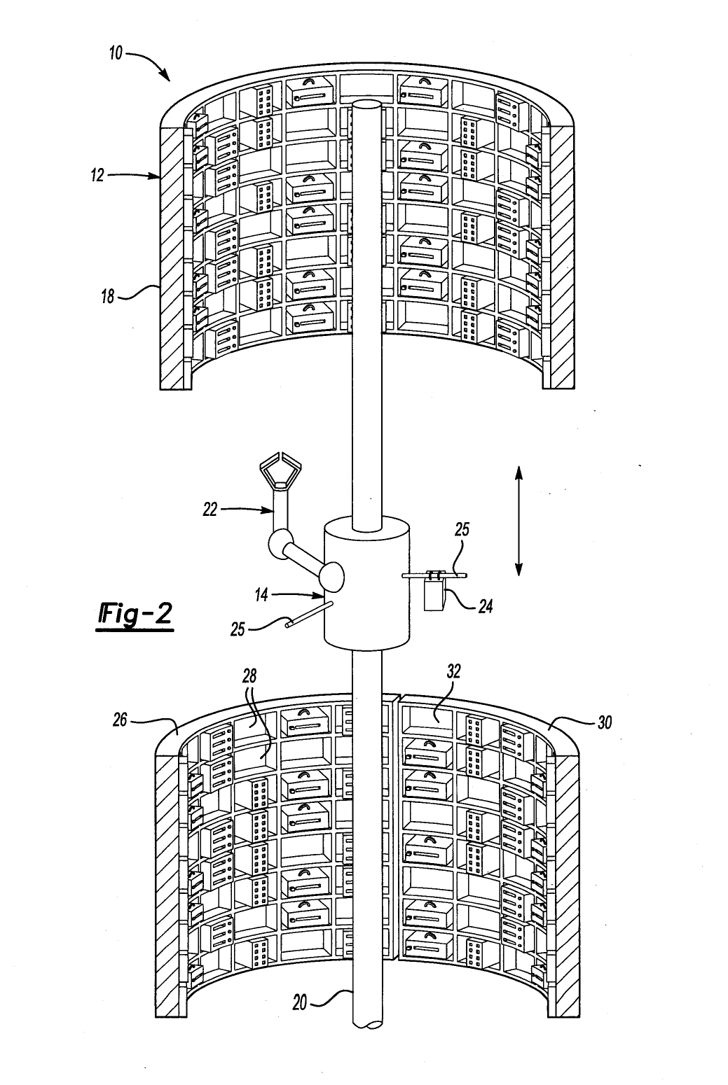

With respect to FIG. 2, an embodiment of self-maintained computer system 10 is illustrated as including a first repository 26. First repository 26 is depicted as a generally cylindrical cabinet having generally the same circumference as cabinet 18. First repository 26 includes a plurality of receptacles 28 for storing spare computer components in good working order. In some embodiments, first repository 26 may include at least one spare component of each type corresponding to the different types of computer components employed by computer system 12. For instance, if computer system 12 comprises servers, power supplies and disk drives, then first repository 26 may include at least one spare server, at least one spare power supply, and at least one spare disk drive. In other embodiments, a plurality of each different type of computer component may be maintained in first repository 26.

In some embodiments, first repository 26 may simply be a housing cabinet where spare computer components 24 rest until needed. In other embodiments, first repository 26 may have detection mechanisms for determining when an individual compartment of first repository 26 is vacant. In this manner, first repository 26 may include a means for determining which types of computer components have failed and therefore may assist in keeping records and calculating statistics of component failure rates. In other embodiments, first repository 26 may send a message to a user of computer system 12 or to the user of a different computer system indicating which spare computer components have been retrieved for replacement purposes and which types of spare computer components need to be replenished in first repository 26.

In operation, when the failure of an individual computer component 16 of computer system 12 is detected, robot 14 may travel to first repository 26 and retrieve a spare computer component 24 of the same type as failed computer component 16. Robot 14 may then travel to the section of cabinet 18 where the failed computer component 16 resides and replace it with spare computer component 24.

FIG. 2 also illustrates a second repository 30. Second repository 30 includes a plurality of receptacles 32 for the storage/housing of failed computer components 14. In the illustrated embodiment, second repository 30 is depicted as being integral with first repository 26. In other embodiments, second repository 30 may be separate from first repository 26. In still other embodiments, first repository 26 may not only house spare computer components 24, but may also house failed computer components 16 subsequent to their replacement and removal from computer system 12. In such embodiments, first repository 26 may be configured to track which of its receptacles contain spare computer components 24 and which of its receptacles contain failed computer components 16. In some embodiments, the first and second repositories 26, 30 may be integral with computer system 12. In other embodiments, first and second repositories 26, 30 may be disposed proximate to computer system 12. In still other embodiments, first and second repositories 26, 30 may be disposed remotely from computer system 12. Such varying configurations affords a system designer greater flexibility when deciding where to house computer system 12. Because a maintainer of computer system 12 need only have access to first and second repositories 26, 30, a computer system such as computer system 12 may be housed in remote or otherwise difficult to access locations. Furthermore, because computer system 12 need only be accessed by robot 14, computer system 12 may be designed to fit into cramped quarters where humans may not be able to gain access to computer system 12. In addition, human error would be removed as a source of malfunction when a robotic system removes and replaces defective components.

With reference to FIGS. 3A and 3B, replacement of a failed computer component 16 is illustrated. In FIG. 3A, robot 14 is disposed proximate receptacle 13 and, through the use of robotic arm 22, docks with failed computer component 16 and extracts it from receptacle 13. In FIG. 3A, robot 14 includes a plurality of component receivers 34 disposed along an outer perimeter of robot 14. As illustrated, one component receiver 34 is empty and another component receiver 34 includes spare computer component 24.

In FIG. 3B, the failed computer component 16 has been placed into the component receiver 34 that was vacant while the spare computer component 24 has been inserted into receptacle 13 of computer system 12. With the replacement complete, robot 14 may travel to first repository 26 where it may then deposit failed computer component 16.

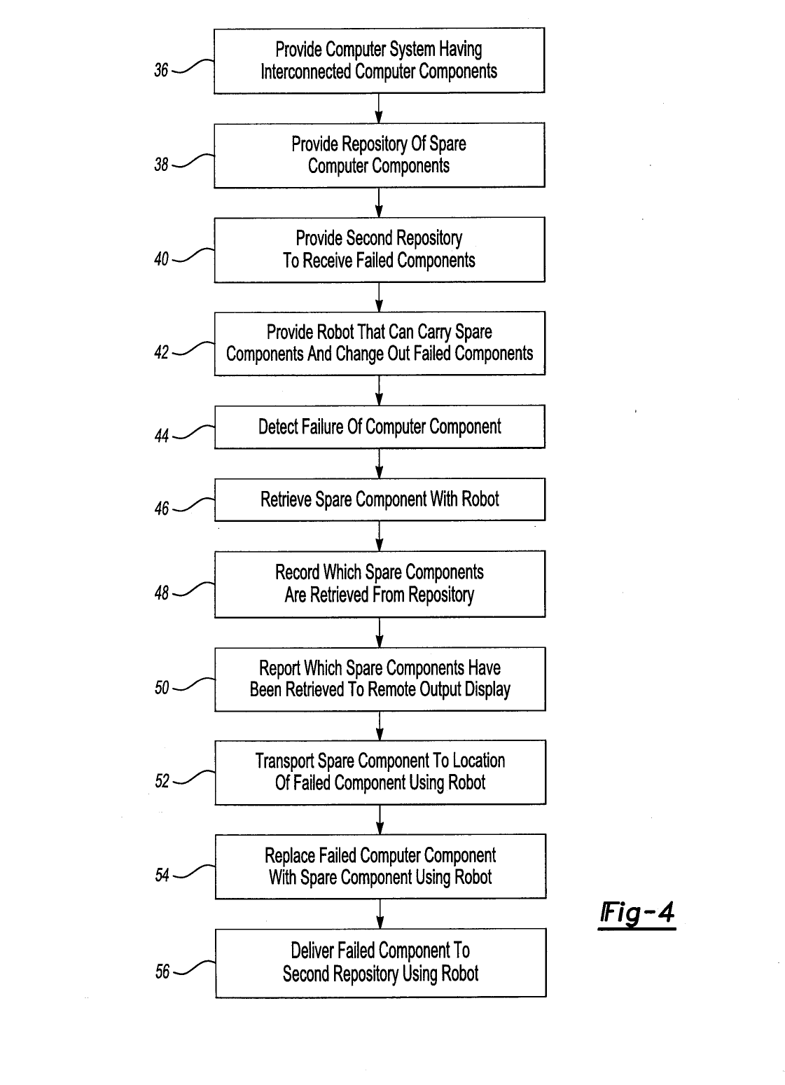

With respect to FIG. 4, a method of employing self-maintained computer system 10 is illustrated in block diagram format. At 36, a computer system having individual interconnected computer components is provided. At 38, a repository of spare computer components is provided. At 40, if desired, a second repository to receive failed components is provided. At 42, a robot that can carry spare components and change out failed components from the computer system is provided. At 44, failure of an individual computer component is detected. At 46, the robot retrieves a spare computer component. At 48, a record is made identifying which spare component or components have been retrieved from the repository by the robot. At 50, a report is generated identifying which spare components have been retrieved and the report is transmitted to a remote location to apprise a user of which computer components require replacement. Steps 48 and 50 are optional. At 52, the robot transports the spare component to the location of the failed component. At 54, the robot replaces the failed computer component with the spare computer component. At 56, the robot delivers the failed computer component to the second repository, if desired. In this manner, a self-maintained computer system such as self-maintained computer system 10 may automatically replace failed components as soon as their failure is detected and thus reduce or even eliminate the need for regularly scheduled preventive maintenance and may also reduce the need for redundancy within computer systems and the associated expense of purchasing and maintaining multiple redundant computer components.

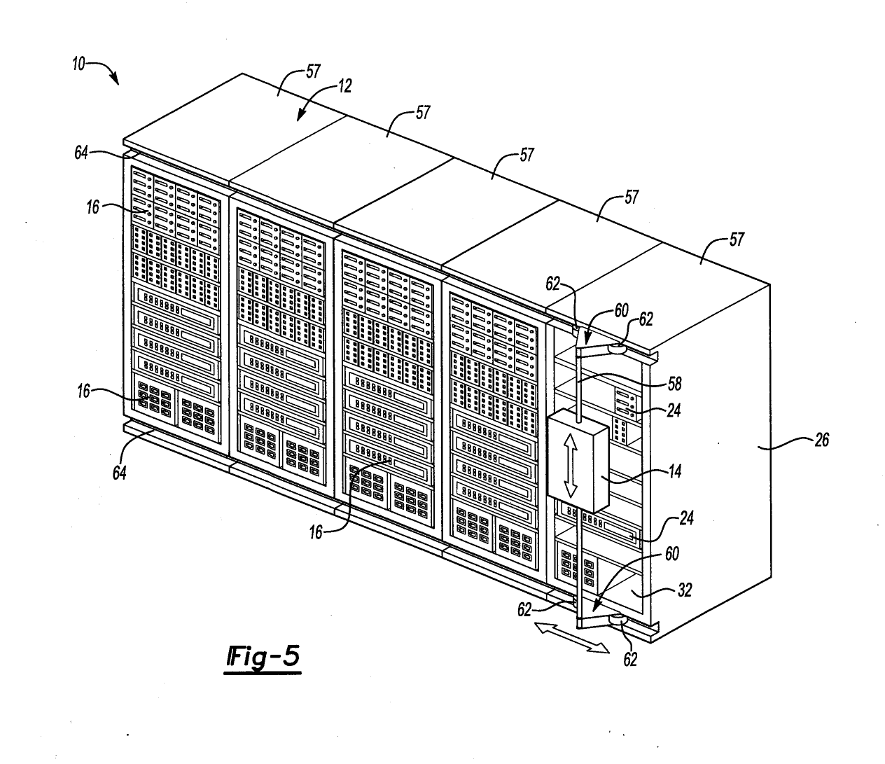

FIGS. 5 through 7 illustrate alternate embodiments of self-maintained computer system 10. FIG. 5 illustrates a perspective view of self-maintained computer system 10 having computer system 12, robot 14 and repository 26. In the embodiment illustrated in FIG. 5, computer system 12 comprises an assembly of individual cabinettes 57 configured in a generally rectangular arrangement. Robot 14 is mounted on robot guide rail 58 which is oriented in a generally upright position to allow robot 14 to move in a generally upwards and downwards direction to permit robot 14 to access varying levels of each individual cabinette 57. At an upper end of robot guide rail 58 is a wheel assembly 60. A second wheel assembly 60 is also disposed at a lower end of robot guide rail 58. Wheel assemblies 60 include a plurality of wheels 62 which are configured to roll within tracks 64.

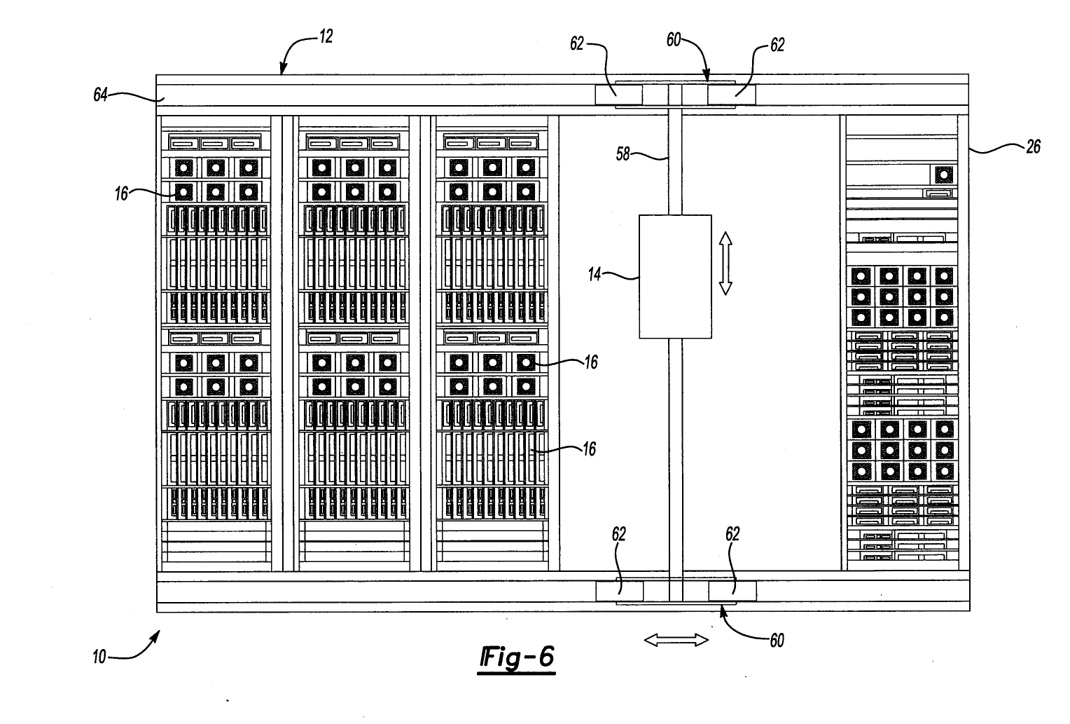

As set forth above, computer system 12 comprises a plurality of individual cabinettes 57 which are disposed adjacent to one another and which may be fastened to one another using any conventional fastening means. Each individual cabinette 57 houses a plurality of computer components 16 and first repository 26 houses a plurality of spare computer components 24. In other embodiments, computer system 12 may comprise a single elongate cabinette 57 (see FIG. 6). In still other embodiments, cabinettes 57 may be arranged in any desirable configuration such as an “L” shaped configuration, a “U” shaped configuration and a square or box shaped configuration, to name a few.

Robot 14 is configured to move in an upward and downward direction along robot guide rail 58 and can move longitudinally along a front face of computer system 12 through engagement between upper and lower wheel assemblies 60 with upper and lower tracks 64, respectively. In the illustrated configuration, robot 14 is disposed proximate a front face of computer system 12 to provide ready access to computer components 16. In other embodiments, rather than an integral track 64, an external track may be mounted proximate a front face of computer system 12 to permit the movement of robot 14 longitudinally with respect to computer system 12. Such an embodiment may be implemented in instances where it is desired to retrofit existing computer systems.

FIG. 6 is a front elevational view illustrating an alternate embodiment of the computer system 12 of FIG. 5. In the embodiment illustrated in FIG. 6, computer system 12 does not comprise an assembly of individual cabinettes 57, but rather, is a single elongate structure. In this embodiment, first repository 26 is integral with computer system 12, but spaced apart from a portion of computer system 12 where computer components 16 are mounted. In some embodiments, it may be desirable to locate first repository 26 a substantial distance from computer components 16 to provide flexibility in a configuring and housing self-maintained computer system 10.

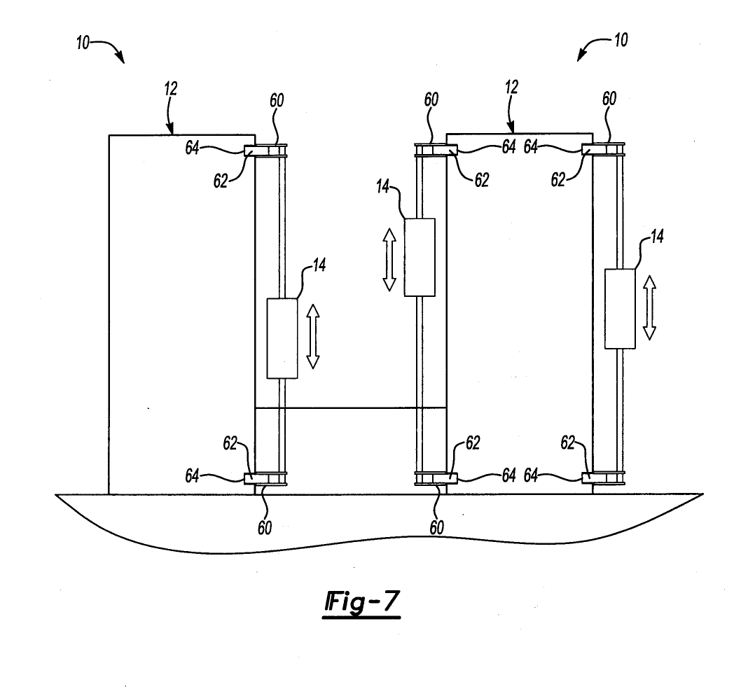

With respect to FIG. 7, side elevational views of different embodiments of self-maintained computer system 10 are illustrated. In this Figure, robot 14 is disposed both in front of, and behind computer system 12. This may be useful in circumstances where computer system 12 has a large width such that it may be advantageous to mount computer components in both a front and rear portion of computer system 12. In other embodiments, a single robot 14 may be employed and track 64 may permit robot 14 to travel around one or both ends of computer system 12 to have access to both the front side and the back side of computer system 12.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A self maintained computer system comprising:
a computer system having a plurality of interconnected computer components; and
a robot associated with the computer system that is configured to carry a spare computer component and further configured to replace a computer component of the computer system with the spare computer component,
wherein the robot automatically replaces an individual computer component when a failure of the individual component is detected.

2. The self maintained computer system of claim 1 wherein the robot is configured to carry a plurality of the spare computer components.

3. The self maintained computer system of claim 1 wherein the plurality of interconnected computer components comprises a plurality of different types of computer components and wherein the robot is configured to carry each different type of computer component utilized by the computer system.

4. The self maintained computer system of claim 3 wherein the plurality of different types of computer components includes server components.

5. The self maintained computer system of claim 3 wherein the plurality of different types of computer components including a component selected from a group consisting of a power supply, a battery and a cooling device.

6. The self maintained computer system of claim 3 wherein the plurality of different types of computer components includes a storage device.

7. The self maintained computer system of claim 1 wherein the plurality of interconnected computer components are positioned in a generally rectangular arrangement.

8. The self maintained computer system of claim 7 wherein the generally rectangular arrangement of computer components forms a wall wherein individual components of the computer system are accessible from both a front portion of the wall and from a rear portion of the wall.

9. The self maintained computer system of claim 1 further comprising a plurality of the spare computer components detachably connected to the robot.

10. The self maintained computer system of claim 1 wherein the computer system has a RAID protocol.

11. A self maintained computer system comprising:
a computer system having a plurality of interconnected computer components;
a repository associated with the computer system, the repository having a spare computer component in good working order; and
a robot associated with the computer system that is configured to carry the spare computer component from the repository to the computer system and further configured to replace an individual component of the computer system with the spare computer component,
wherein one of the computer system and the robot are capable of detecting a failure of any individual computer component of the computer system and wherein the robot automatically replaces a failed computer system component with the spare computer component upon the detection of a failure of an individual computer component of the computer system.

12. The self maintained computer system of claim 11 wherein the repository is disposed proximate the computer system.

13. The self maintained computer system of claim 11 wherein the repository comprises a first repository, wherein the self maintained computer system further comprises a second repository, and wherein the robot is configured to deliver failed computer components from the computer system to the second repository.

14. The self maintained computer system of claim 13 wherein the second repository is disposed proximate the first repository.

15. The self maintained computer system of claim 11 wherein the plurality of interconnected computer components are positioned in a generally rectangular arrangement.

16. The self maintained computer system of claim 11 wherein the generally rectangular arrangement of computer components forms a wall wherein individual components of the computer system are accessible from both a front portion of the wall and from a rear portion of the wall.

17. A method of maintaining a computer system comprising:
providing a computer system having a plurality of interconnected computer components;
providing a repository having a spare computer component in good working order;
providing a robot that is configured to carry the spare computer component and further configured to replace an individual computer component of the computer system with the spare computer component;
detecting a failure of one of the computer components of the computer system;
retrieving the spare computer component from the repository using the robot;
transporting the spare computer component to a location within the computer system where the failed computer component is located using the robot; and
replacing the failed computer component of the computer system with the spare computer component using the robot.

18. The method of claim 17, the repository comprising a first repository, the method further comprising the steps of providing a second repository and delivering the failed computer component to the second repository using the robot.

19. The method of claim 17, the repository having a plurality of the spare computer components, the method further comprising the step of recording which spare components have been retrieved from the repository.

20. The method of claim 19 further comprising the step of communicating a message to a remote location identifying which spare components have been retrieved from the repository.
